(19) United States
(12) Patent Application Publication
(10) Pub. No.: US 2008/0000198 A1
(43) Pub. Date: Jan. 3, 2008

(54) Apparatus and method for disengaging mating zipper elements of packaging bag with zipper

(75) Inventor: Masakazu Setozaki, Iwakuni-shi (JP)

Correspondence Address: Daniel P. Burke, Esq;DANIEL P. BURKE & ASSOCIATES, PLLC, Suite 131, 300 Rabro Drive, Hauppauge, NY, 11788, US

(73) Assignee: Toyo Jidoki Co., Ltd.

(21) Appl. No.: 11/805,454

(22) Filed: May 23, 2007

(30) Foreign Application Priority Data
Jun. 2, 2006 (JP) 2006-154212

(51) Int. Cl. B26D 7/27

(52) U.S. Cl. 53/396

(57) ABSTRACT

A packaging bag with a zipper having a pair of male and female zipper elements is gripped at the laterally opposite side edges thereof with a pair of grippers. A pair of suction-adhering members are disposed at both sides of the packaging bag and actuated to adhere to the respective outsides of the male and female zipper elements of the bag. In this state, the suction-adhering members are moved away from each other, thereby disengaging the male and female zipper elements from each other. At this step, the suction-adhering member adhering to the outside of the male zipper element is pivoted to displace the suction-adhering portion thereof toward the mouth of the bag, thereby pulling the male zipper element obliquely upward.

### BACKGROUND OF THE INVENTION

1. Field of the Invention

The present invention relates to an apparatus and method for disengaging the mating zipper elements of a packaging bag with a zipper (hereinafter, a packaging bag with a zipper will be occasionally referred to as a “zippered packaging bag”). More particularly, the present invention relates to a zipper element disengaging apparatus and method suitable for use in an automatic packaging machine that performs automatic packaging of food or the like while moving a packaging bag with the laterally opposite side edges thereof being gripped with a pair of grippers, wherein a bag with a zipper is used as the packaging bag.

2. Discussion of Related Art

There has been used a zippered bag whose mouth is reclosable by fitting engagement between a rib and an associated groove that constitute a zipper. More specifically, the rib is formed as a male zipper element that extends in the width direction on one of the inner surfaces of the opposed walls of the bag near the top edge thereof. The groove is formed as a female zipper element with a groove shape corresponding to the rib that extends widthwise on the other of the inner surfaces of the bag walls. The zippered bag is usable in automatic packaging of food or the like. When the zippered bag is used, it has to be opened before filling of food or the like as the contents of the bag. A variety of apparatus and methods for disengaging the zipper elements of the zippered bag have been proposed.

Japanese Patent No. 3578924 discloses an apparatus and method for disengaging zipper elements of a zippered packaging bag. In this apparatus and method, suction cups supported by respective support blocks are actuated to adhere to a packaging bag at the respective outsides of male and female elements of a seal (zipper) that are formed on the mutually opposing inner surfaces of the bag. Then, the free end of at least one of the support blocks is moved downward along the outer surface of the bag, thereby causing the cup supported by this support block to tilt pivotally about the lower end thereof, and thus disengaging the male zipper element from the female zipper element.

In general, the zipper of a zippered bag has a structure as shown in FIG. 1, which is a fragmentary enlarged vertical sectional view. FIG. 1 shows an essential part of a packaging bag 1 in a state where a zipper 2 thereof is closed. Reference numeral 1a denotes a mouth of the packaging bag 1. The zipper 2 comprises a male element 3 having a distal end with a circular sectional configuration and a female element 4 having a groove for receiving the male element 3. The groove of the female element 4 is formed by upper and lower arcuate walls 4a and 4b. As illustrated in the figure, the lower wall 4b is, in general, longer than the upper wall 4a. The reason for this is to prevent the zipper 2 from being undesirably unzipped by the pressure in the bag 1 when an external force is applied to the bag 1, for example, and, at the same time, to enable the bag 1 to be opened relatively easily from the bag mouth 1a side.

When a packaging bag that is to be opened by the apparatus and method disclosed in Japanese Patent No. 3578924 has the above-described zipper structure, the male element 3 is moved in a downward-concave arc to disengage from the female element 4. Therefore, unzipping of the zipper 2 takes place in such a manner that the lower wall 4b, which is longer than the upper wall 4a, is mainly pushed open. Accordingly, the male element 3 is not easy to disengage from the female element 4 because it is long. In addition, because the radius of rotation of the suction cup from the pivot point to the zipper 2 is small, the lower wall 4b needs to be deformed to a considerable extent. Thus, it is difficult to unzip the zipper 2.

### SUMMARY OF THE INVENTION

The present invention has been made in view of the above-described problems associated with the related art.

Accordingly, an object of the present invention is to provide an apparatus and method for disengaging the mating zipper elements of a zippered packaging bag capable of unzipping the zipper more easily than the related-art apparatus and method. Noting the above-described zipper structure, the present invention is configured to move the male element 3 in a direction in which it disengages from the female element 4 most easily, specifically in the direction of the arrow shown in FIG. 1.

The present invention provides a zipper element disengaging apparatus for a packaging bag with a zipper having a pair of mating male and female zipper elements. The apparatus has a pair of grippers that grip the laterally opposite side edges of the packaging bag. A pair of suction-adhering members are disposed in opposed relation to each other at both sides of the packaging bag. The suction-adhering members are actuated to adhere to opposite side surfaces of the packaging bag in opposed relation to each other at the respective outsides of the male zipper element and the female zipper element, and the suction-adhering members adhering to the packaging bag are moved away from each other, thereby disengaging the male zipper element and the female zipper element from each other. The apparatus includes the pair of suction-adhering members having respective suction-adhering portions that adhere to the packaging bag, and an advancing and retracting device that holds the suction-adhering members and moves the suction-adhering members toward and away from each other. The apparatus further includes a suction-adhering member actuating device that moves at least one of the suction-adhering members between a mutually facing position where the suction-adhering portions of the suction-adhering members face each other and a displaced position where the suction-adhering portion of the suction-adhering member adhering to the outside of the male zipper element is displaced toward the mouth of the packaging bag relative to the suction-adhering portion of the suction-adhering member adhering to the outside of the female zipper element. When the suction-adhering members are moved away from each other by a predetermined distance by the advancing and retracting device, the suction-adhering member actuating device moves the at least one of the suction-adhering members from the mutually facing position to the displaced position.

According to a specific arrangement of the present invention, the suction-adhering member actuating device moves the suction-adhering member adhering to the outside of the male zipper element so that the suction-adhering portion of the suction-adhering member is displaced toward the mouth of the packaging bag.

According to another specific arrangement of the present invention, the suction-adhering member actuating device moves the suction-adhering member adhering to the outside of the female zipper element so that the suction-adhering portion of the suction-adhering member is displaced away from the mouth of the packaging bag.

According to still another specific arrangement of the present invention, the suction-adhering member actuating device moves both the suction-adhering members so that the suction-adhering portion of the suction-adhering member adhering to the outside of the male zipper element is displaced toward the mouth of the packaging bag, and the suction-adhering portion of the suction-adhering member adhering to the outside of the female zipper element is displaced away from the mouth of the packaging bag.

According to a further specific arrangement of the present invention, while the suction-adhering members remain at respective positions away from each other by the predetermined distance, the suction-adhering member actuating device returns the suction-adhering member moved to the displaced position to the mutually facing position and then, if necessary, reciprocates the suction-adhering member between the mutually facing position and the displaced position at least one more time.

In addition, the present invention provides a zipper element disengaging method for a packaging bag with a zipper having a pair of mating male and female zipper elements. The method includes the steps of gripping the laterally opposite side edges of the packaging bag with a pair of grippers, disposing a pair of suction-adhering members having respective suction-adhering portions in opposed relation to each other at both sides of the packaging bag, actuating the suction-adhering members so that the suction-adhering portions thereof adhere to the packaging bag in opposed relation to each other at the respective outsides of the male zipper element and the female zipper element, and moving the suction-adhering members adhering to the packaging bag away from each other, thereby disengaging the male zipper element and the female zipper element from each other. In the step of moving the suction-adhering members away from each other, at least one of the suction-adhering members is moved from a mutually facing position where the suction-adhering portions of the suction-adhering members face each other to a displaced position where the suction-adhering portion of the suction-adhering member adhering to the outside of the male zipper element is displaced toward the mouth of the packaging bag relative to the suction-adhering portion of the suction-adhering member adhering to the outside of the female zipper element.

According to a specific arrangement of the present invention, in the step of moving the suction-adhering members away from each other, the suction-adhering member adhering to the outside of the male zipper element is moved from the mutually facing position to a displaced position where the suction-adhering portion of the suction-adhering member is displaced toward the mouth of the packaging bag.

According to another specific arrangement of the present invention, in the step of moving the suction-adhering members away from each other, the suction-adhering member adhering to the outside of the female zipper element is moved from the mutually facing position to a displaced position where the suction-adhering portion of the suction-adhering member is displaced away from the mouth of the packaging bag.

According to still another specific arrangement of the present invention, in the step of moving the suction-adhering members away from each other, both the pair of suction-adhering members are moved so that the suction-adhering portion of the suction-adhering member adhering to the outside of the male zipper element is displaced toward the mouth of the packaging bag, and at the same time, the suction-adhering portion of the suction-adhering member adhering to the outside of the female zipper element is displaced away from the mouth of the packaging bag.

According to a further specific arrangement of the present invention, while the suction-adhering members remain at respective positions away from each other by the predetermined distance, the suction-adhering member moved to the displaced position is returned to the mutually facing position and then, if necessary, reciprocated between the mutually facing position and the displaced position at least one more time.

Thus, according to the present invention, the male zipper element is pulled out from the female zipper element obliquely upward. Therefore, the lower wall of the female zipper element need not be substantially deformed, and the upper wall thereof also need not be excessively deformed. Disengagement of the male zipper element from the female zipper element occurs when the male zipper element moves through a shorter distance than in the case where the lower wall of the female zipper element is mainly deformed. Therefore, the zipper elements can be disengaged from each other easily and reliably.

Other objects and advantages of the present invention will become apparent from the following detailed description of illustrated embodiments of the invention.

### BRIEF DESCRIPTION OF THE DRAWINGS

FIG. 1 is a fragmentary sectional view showing the details of a zipper part of a zippered packaging bag.

FIG. 2 is a perspective view showing the conceptual arrangement of an automatic packaging machine employing a zipper element disengaging apparatus according to the present invention.

FIGS. 3A and 3B are a plan view and a side view, respectively, showing an essential part of a zipper element disengaging apparatus according to a first embodiment of the present invention in a state where male- and female-side suction cups are away from each other at a mutually facing position.

FIGS. 4A and 4B are a plan view and a side view, respectively, showing the essential part of the zipper element disengaging apparatus in a state where the two suction cups have adhered to a packaging bag.

FIGS. 5A and 5B are a plan view and a side view, respectively, showing the essential part of the zipper element disengaging apparatus in a state where the two suction cups have moved away from each other, and the male-side suction cup is placed at a displaced position.

FIGS. 6A and 6B are a plan view and a side view, respectively, showing the essential part of the zipper element disengaging apparatus in a state where the male-side suction cup has returned to the mutually facing position while the two suction cups remain at the positions away from each other.

FIGS. 7A and 7B are a plan view and a side view, respectively, showing the essential part of the zipper element disengaging apparatus in a state where the male-side suction cup has moved to the displaced position again while the two suction cups remain at the positions away from each other.

FIGS. 8A and 8B are a plan view and a side view, respectively, showing the essential part of the zipper element disengaging apparatus in a state where the male-side suction cup has returned to the mutually facing position while the two suction cups remain at the positions away from each other.

FIG. 9 is a fragmentary sectional view showing a change from a state where the zipper is closed to a state where the zipper elements have been disengaged from each other.

FIGS. 10A and 10B are a plan view and a side view, respectively, showing the essential part of the zipper element disengaging apparatus in a state where opening of the packaging bag has begun as the zipper elements disengage from each other.

FIGS. 11A and 11B are a plan view and a side view, respectively, showing the essential part of the zipper element disengaging apparatus in a state where the suction cups have separated from the packaging bag upon completion of the opening of the bag.

FIGS. 12A and 12B show one operation step of a zipper element disengaging apparatus according to a second embodiment of the present invention corresponding to the operation step in the first embodiment shown in FIGS. 3A and 3B.

FIGS. 13A and 13B show another operation step of the zipper element disengaging apparatus according to the second embodiment corresponding to the operation step in the first embodiment shown in FIGS. 5A and 5B.

FIGS. 14A and 14B show one operation step of a zipper element disengaging apparatus according to a third embodiment of the present invention corresponding to the operation step in the first embodiment shown in FIGS. 3A and 3B.

FIGS. 15A and 15B show another operation step of the zipper element disengaging apparatus according to the third embodiment corresponding to the operation step in the first embodiment shown in FIGS. 5A and 5B.

### DETAILED DESCRIPTION OF THE PREFERRED EMBODIMENTS

Embodiments of the present invention will be described below with reference to the accompanying drawings. It should be noted that the following embodiments are for illustrative purposes only, and that the scope of the present invention is not limited to these embodiments.

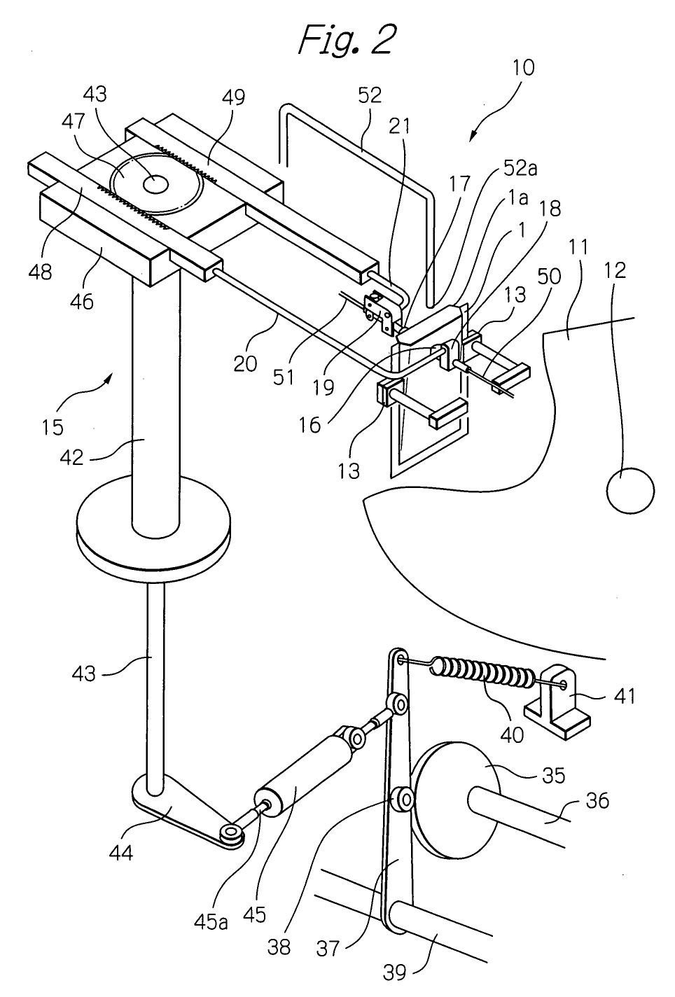

FIG. 2 is a perspective view conceptually showing an automatic packaging machine 10 for food that employs an apparatus for disengaging zipper elements of a zippered packaging bag according to one embodiment of the present invention. In the figure, a turntable 11 is secured to a rotating shaft 12 driven by a driving device (not shown) so that the turntable 11 is rotatable together with the rotating shaft 13 as one unit. The turntable 11 rotates intermittently. A pair of grippers 13 are disposed underneath the turntable 11 near the outer periphery thereof with a predetermined spacing therebetween in the circumferential direction to grip the laterally opposite side edges of a bag 1. The grippers 13 receive the bag 1 supplied from the outside of the turntable 11 and move it in a vertically held position to various steps successively to perform operations such as opening the bag mouth 1a and filling the bag 1 with contents. For these operations or arrangements therefor, publicly known techniques can be used satisfactorily, except a zipper element disengaging apparatus (described later). Therefore, a detailed description thereof is omitted. The arrangement for securing the grippers 13 to the turntable 11 and the operation thereof are also publicly known. Therefore, a detailed description thereof is omitted.

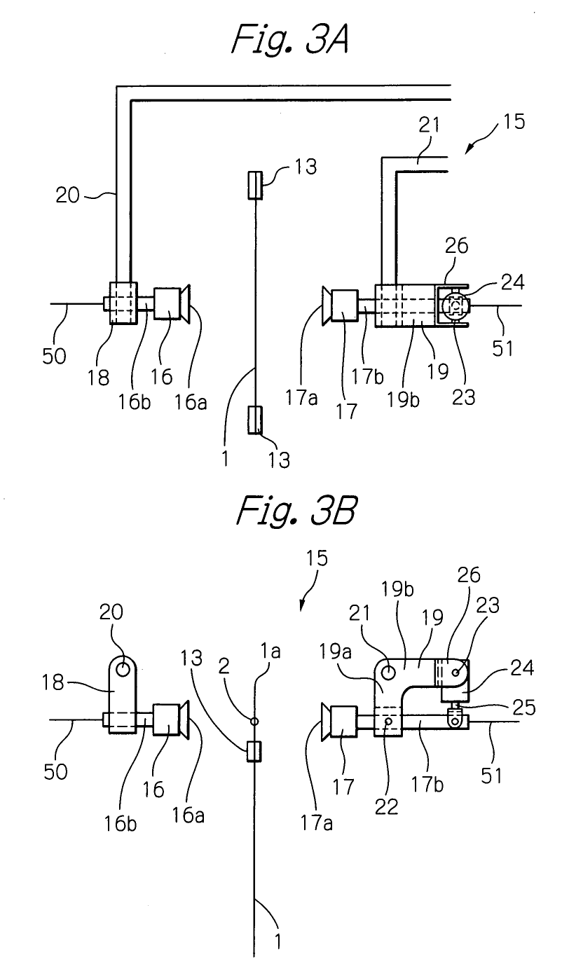

A first embodiment of the zipper element disengaging apparatus according to the present invention will be described below in detail with reference to FIG. 2 and also FIGS. 3A, 3B and those following. In this embodiment, the operation of opening the bag mouth 1a after unzipping the zipper 2 is also performed by using the same zipper element disengaging apparatus, as will be described later. However, an apparatus for opening the bag mouth 1a may be provided separately from the zipper element disengaging apparatus.

A zipper element disengaging apparatus 15 has suction cups 16 and 17 as suction-adhering members that are secured through respective holders 18 and 19 to a pair of arms 20 and 21 that are movable toward and away from each other. The way in which the suction cups 16 and 17 are secured to the arms 20 and 21 and the operation of the suction cups 16 and 17 will be detailed later. A mechanism for operating the arms 20 and 21 will be explained below. It should be noted the arm-driving mechanism is not necessarily limited to the one that is arranged as stated below.

A cam 35 is secured to a cam shaft 36 driven to rotate by a driving device (not shown) so that the cam 35 rotates together with the cam shaft 36 as one unit. A cam lever 37 is secured to a lever shaft 39 rotatably supported appropriately so that the cam lever 37 pivots together with the lever shaft 39 as one unit. The cam lever 37 rotatably supports a cam roller 38 at a longitudinally intermediate position thereon. One end of a return spring 40, which is a tension coil spring, is attached to the distal end of the cam lever 37. The other end of the spring 40 is attached to a spring hook 41 secured to a frame (not shown). Accordingly, the cam lever 37 is constantly urged in a direction in which the cam roller 38 contacts the outer peripheral surface of the cam 35. The outer profile of the cam 35 is shaped to allow the arms 20 and 21 to perform the later-described operations.

A hollow stand 42 is stood on the top of a machine base (not shown). The stand 42 rotatably supports a driving shaft 43. A connecting lever 44 is secured at one end thereof to the lower end of the driving shaft 43 so that the lever 44 is rotatable together with the driving shaft 43 as one unit. One end of an air cylinder 45 is pivotably attached to the other end of the lever 44. The other end of the air cylinder 45 is pivotably attached to the cam lever 37 at a longitudinally intermediate position thereon between the cam roller 38 and the end thereof to which the spring 40 is attached. The air cylinder 45 is connected to a compressed air source (not shown). Compressed air is supplied to and exhausted from the air cylinder 45 under appropriate control, causing a rod 45a to extend and contract in response to the supply and exhaust of compressed air, thereby moving the arms 20 and 21 and the suction cups 16 and 17 as described later.

A plate-shaped gear holder 46 is secured to the upper end of the stand 42 as shown in the figure. A pinion 47 is positioned in a recess (no reference numeral) formed in an approximately central portion of the gear holder 46 and fixed to the upper end of the driving shaft 43. Racks 48 and 49 are disposed and guided in respective slots (no reference numeral) formed on the gear holder 46. The racks 48 and 49 extend parallel to each other across the pinion 47. As the pinion 47 rotates, the racks 48 and 49 move opposite to each other in their longitudinal directions. The above-described arms 20 and 21 are integrally secured to the respective distal ends of the racks 48 and 49. The arms 20 and 21 both have an L-shape as shown in the figure. The arm 20 associated with the suction cup 16 is longer than the other arm 21, so that the suction cups 16 and 17 are positioned facing each other across the bag 1 as illustrated in the figure. Piping tubes 50 and 51 are connected to the suction cups 16 and 17, respectively. The tubes 50 and 51 are connected to a vacuum pump through appropriate members, such as a switching valve and a filter. A nozzle 52 is disposed so that an open end 52a thereof is positioned slightly above the mouth 1a of the bag 1. The nozzle 52 injects air to assist the operation of the suction cups 16 and 17 to unzip the bag 1 and to open the bag mouth 1a. It should be noted that illustration of the nozzle 52 is omitted in FIG. 3A and those following.

The suction cups 16 and 17 and an arrangement relating thereto will be further explained below with reference to FIGS. 3A and 3B, which are a plan view and a side view, respectively, of the zipper element disengaging apparatus 15. It should be noted that the suction cup 16 that is shown on the left-hand side in FIGS. 3A and 3B is adapted to adhere to the packaging bag 1 at the outside of the female element 4 of the zipper 2 and will hereinafter be referred to as the “female-side suction cup 16”. The suction cup 17 shown on the right-hand side in FIGS. 3A and 3B is adapted to adhere to the bag 1 at the outside of the male element 3 of the zipper 2 and will hereinafter be referred to as the “male-side suction cup 17”. The female-side suction cup 16 has a suction-adhering portion 16a on a side thereof that faces the bag 1. The suction-adhering portion 16a is a publicly-known one that is formed in a conical shape from rubber, for example. The female-side suction cup 16 is secured to the holder 18 at a shaft portion 16b thereof opposite the suction-adhering portion 16a. The holder 18 is secured to the distal end of the arm 20.

The male-side suction cup 17 has also a publicly-known suction-adhering portion 17a and is held by the holder 19 at a position where the suction-adhering portion 17a faces the suction-adhering portion 16a of the female-side suction cup 16. The holder 19 has, as shown in FIG. 3B, an L-shape as seen in a side view and is secured to the distal end of the arm 21 at a portion thereof where it is bent substantially at right angles. The male-side suction cup 17 has a relatively long shaft portion 17b on a side thereof opposite the suction-adhering portion 17a and is pivotably attached to the vertical portion 19a of the holder 19 through a pin 22 at a position closer to the left end of the shaft portion 17b than the midpoint thereof. An air cylinder 24 is pivotably attached to the end of the horizontal portion 19b of the holder 19 through a bracket 26 and a pin 23 so that a rod 25 of the air cylinder 24 extends downward. The rod 25 is pivotably attached at the distal end thereof to the end of the shaft portion 17b of the male-side suction cup 17. Accordingly, in response to the extension or contraction of the rod 25 of the air cylinder 24, the male-side suction cup 17 pivots clockwise or counterclockwise about the pin 22.

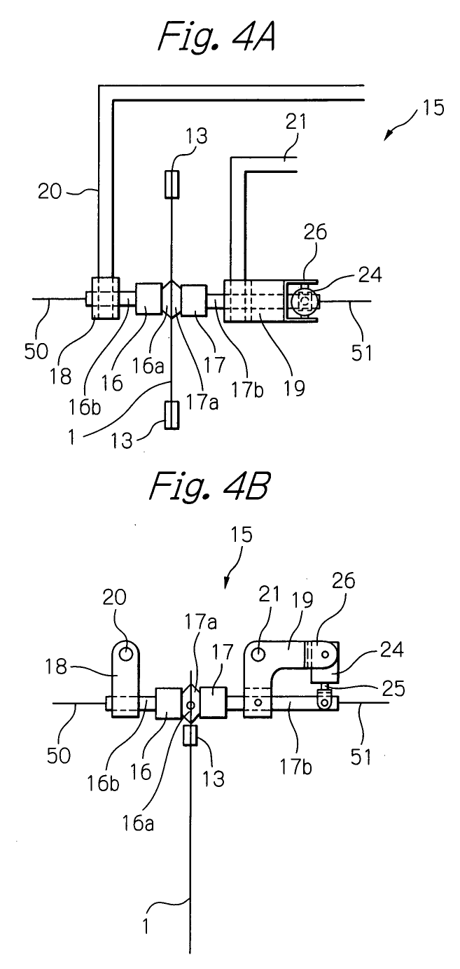

Next, an operation of unzipping the zipper 2 will be explained. In FIGS. 3A and 3B, the suction cups 16 and 17 are separated from each other at a predetermined distance by the action of the cam 35 and the members associated therewith. The bag 1 is moved between the suction cups 16 and 17 16 and stopped. Thereupon, the arms 20 and 21 are moved by the action of the cam 35, causing the suction cups 16 and 17 to move toward each other, so that the suction-adhering portions 16a and 17a of the suction cups 16 and 17 are, as shown in FIGS. 4A and 4B, pressed against the bag 1 at the respective outsides of the female element 4 and the male element 3 of the zipper 2, facing each other across the bag 1. At this time, a vacuum is applied to the suction cups 16 and 17 through the piping tubes 50 and 51, causing the suction-adhering portions 16a and 17a to adhere to the bag 1.

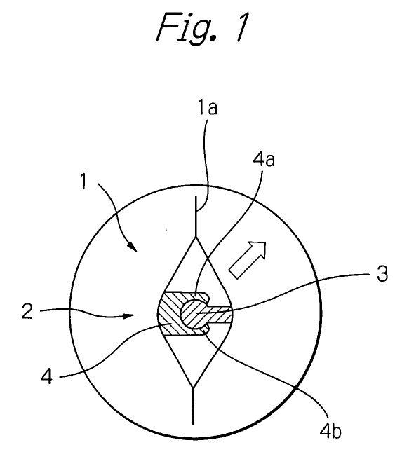

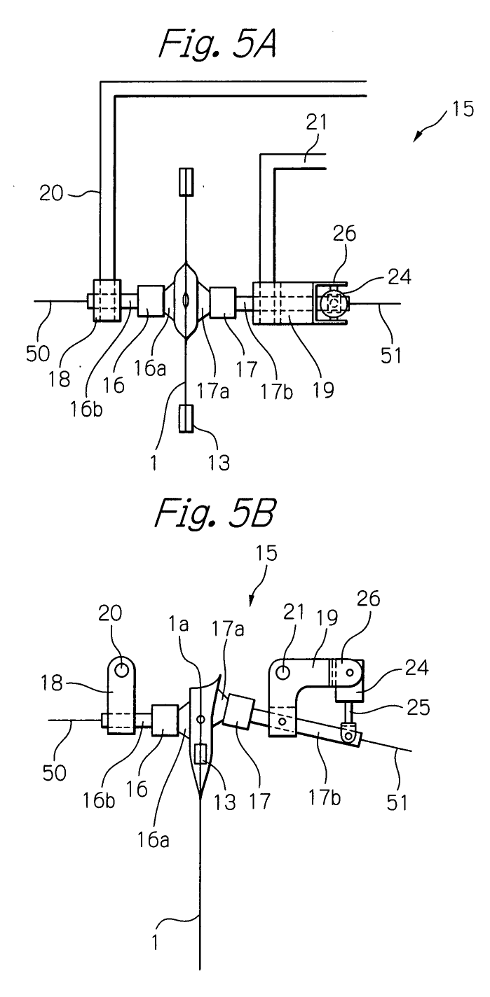

Next, the arms 20 and 21 are moved in respective directions opposite to the above by the action of the cam 35, causing the suction cups 16 and 17 to move away from each other by a predetermined distance. At this time, because the female-side suction cup 16 is fixed to the holder 18, the shaft portion 16b thereof retracts while keeping the horizontal position. In contrast, the male-side suction cup 17 retracts while pivoting clockwise by a predetermined angle about the pin 22. That is, at the same time as the retraction of the male-side suction cup 17 begins, the rod 25 of the air cylinder 24 extends by a predetermined length, thereby causing the suction cup 17 to pivot clockwise by a predetermined angle about the pin 22. Accordingly, the suction-adhering portion 17a of the male-side suction cup 17 moves upward obliquely to the right as shown in FIGS. 5A and 5B from the position shown in FIGS. 4A and 4B to a displaced position where the suction-adhering portion 17a is displaced toward the mouth 1a of the bag 1 relative to the suction-adhering portion 16a of the female-side suction cup 16. During this movement of the male-side suction cup 17, the male element 3 of the zipper 2 is pulled relative to the female element 4 in the arrow direction shown in FIG. 1 by the action of the suction-adhering portion 17a. Consequently, the zipper 2 is slightly unzipped at a portion thereof to which the suction cups 16 and 17 are stuck, but not unzipped completely yet. It should be noted that during the operation of shifting from the position shown in FIGS. 4A and 4B to the position shown in FIGS. 5A and 5B, the spacing between the pair of grippers 13 gripping the laterally opposite side edges of the bag 1 is kept as it is in FIGS. 4A and 4B, but not narrows. Nonetheless, the suction cups 16 and 17 move away from each other. Therefore, the suction-adhering portions 16a and 17a of the suction cups 16 and 17 are slightly elastically deformed.

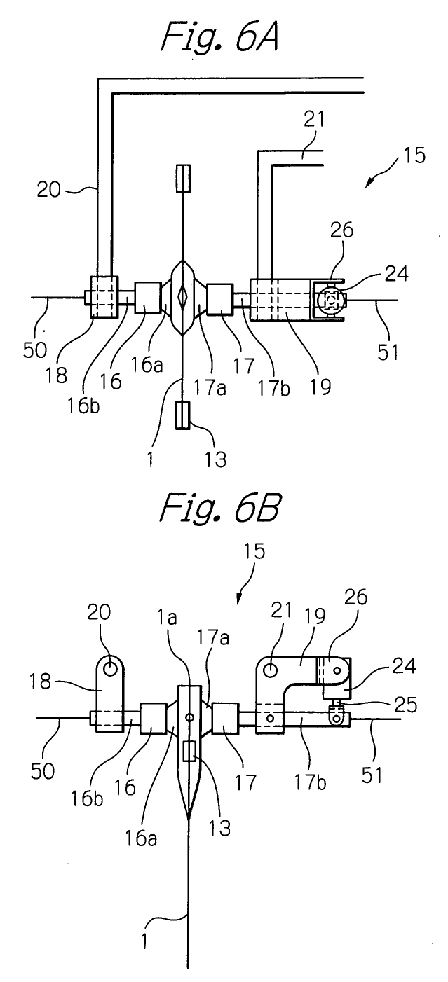

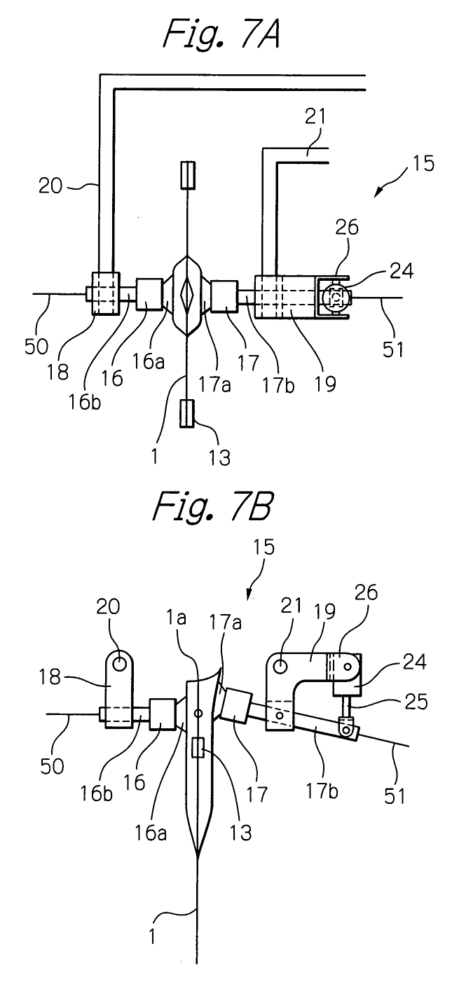

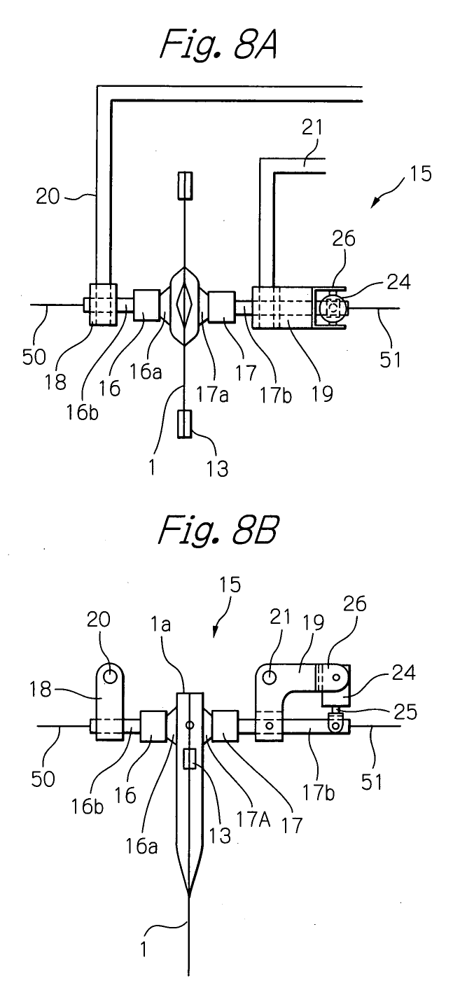

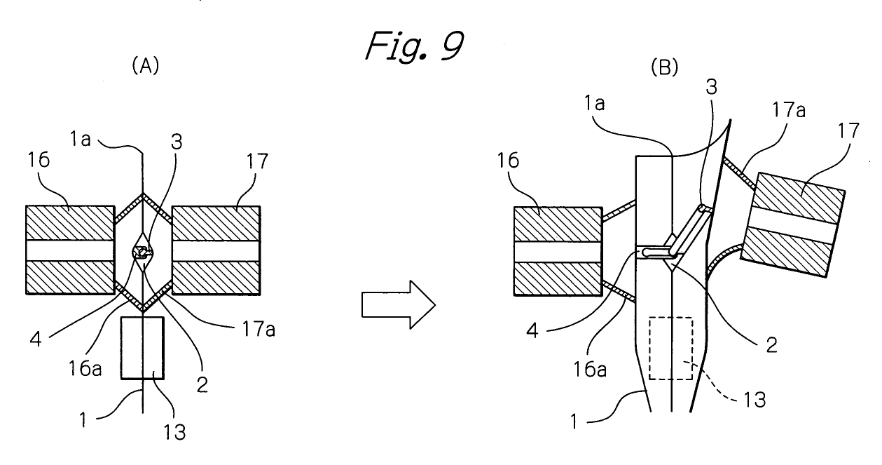

Next, as shown in FIGS. 6A and 6B, the rod 25 of the air cylinder 24 contracts to the previous position while the arms 20 and 21 remain at the positions shown in FIGS. 5A and 5B. As a result, the suction cup 17 pivots counterclockwise about the pin 22, and the suction-adhering portion 17a returns to the previous position, that is, the mutually facing position where it faces the suction-adhering portion 16a of the suction cup 16. This action of the suction cup 17 further promotes the unzipping of the zipper 2 at the portion thereof to which the suction cups 16 and 17 are stuck. Further, the rod 25 of the air cylinder 24 goes through one cycle of extension and contraction while the suction cups 16 and 17 are at rest at the above-described positions. As a result, the state shown in FIGS. 8A and 8B is reached through the state shown in FIGS. 7A and 7B. In the course of this operation, the unzipping of the zipper 2 is further promoted. In the state shown in FIGS. 8A and 8B, the zipper 2 has been completely unzipped at the portion thereof to which the suction cups 16 and 17 are stuck. FIG. 9 shows the way in which the unzipping of the zipper 2 proceeds at the portion thereof to which the suction cups 16 and 17 are stuck. Part A of FIG. 9 shows the state shown in FIGS. 4A and 4B. Part B of FIG. 9 shows the state shown in FIGS. 7A and 7B. During the above-described operation also, the spacing between the grippers 13 does not narrow but remains as it is in FIGS. 4A and 4B.

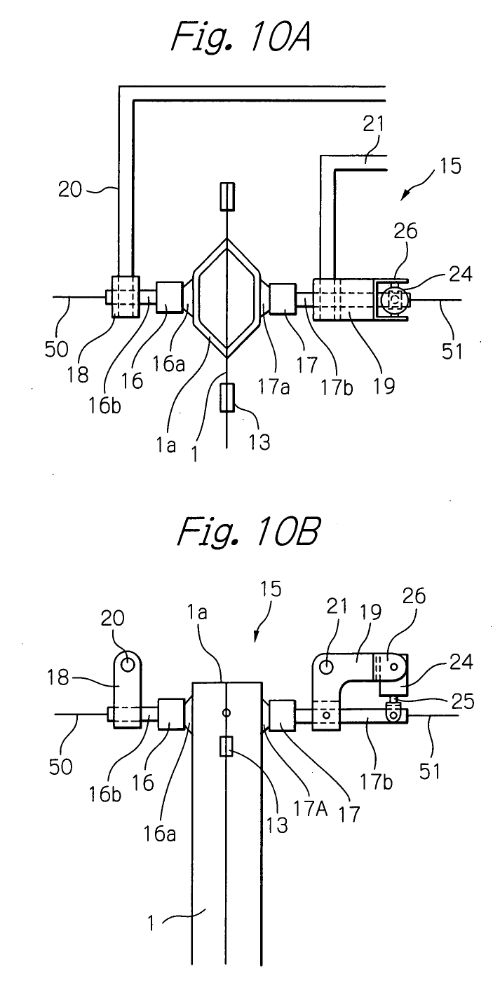

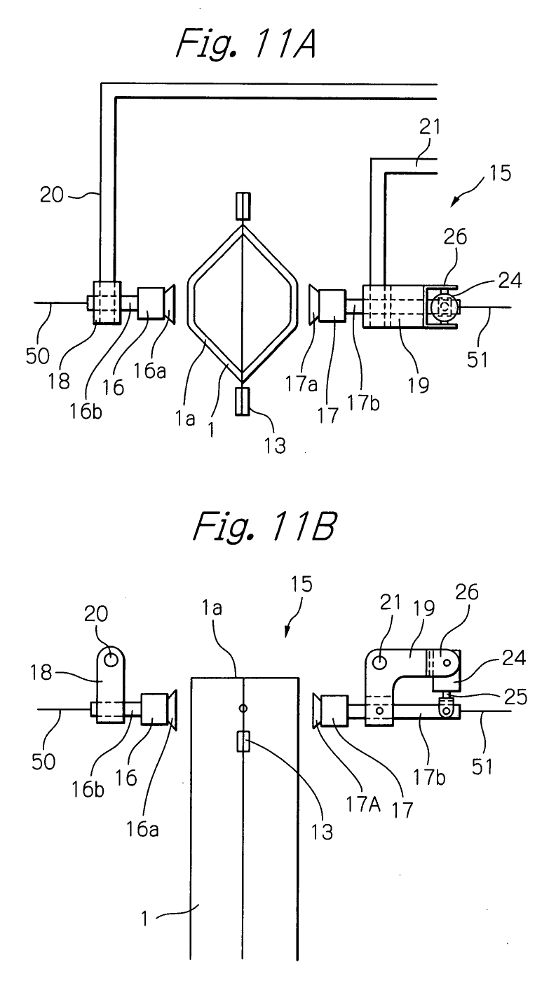

Once a part of the zipper 2 has been unzipped completely, it is very easy to unzip the rest of it. The rest of the zipper 2 can be unzipped simply by opening the bag mouth 1a in an ordinary manner without the need to perform an extra unzipping operation. That is, when the state shown in FIGS. 8A and 8B has been reached, the arms 20 and 21 are moved gradually away from each other by the action of the cam 35. Unzipping of the rest of the zipper 2 proceeds as the arms 20 and 21 move away from each other (see FIGS. 10A and 10B). The spacing between the grippers 13 gradually narrows in synchronism with the movement of the arms 20 and 21. When the whole zipper 2 has been completely unzipped to open the bag mouth 1a, the application of the vacuum is stopped, but the arms 20 and 21 are further moved. Consequently, the suction cups 16 and 17 separate from the bag 1 (see FIGS. 11A and 11B). Although in this embodiment the zipper element disengaging apparatus is also used to perform the bag mouth opening operation after the unzipping operation, the bag mouth opening operation may be performed by using another apparatus, as has been stated above.

In the foregoing embodiment, the male-side suction cup 17 moves to the displaced position first and then returns to the mutually facing position. Thereafter, the male-side suction cup 17 repeats the reciprocating movement to and from the displaced position one more time. The number of times of the reciprocating movement, however, is not necessarily limited to the above but should preferably be determined according to the stiffness of the zipper of the packaging bag. If the zipper is relatively easy to unzip, the reciprocating movement may need to be performed only once. If the zipper can be satisfactorily unzipped only by the first movement to the displaced position, the operation of returning the male-side suction cup 17 to the mutually facing position may be performed at the same time as the bag mouth opening operation is carried out after the unzipping operation.

In the foregoing embodiment, the male-side suction cup is pivoted by using an air cylinder so that the suction-adhering portion thereof moves between the mutually facing position and the displaced position. It should be noted, however, that the female-side suction cup may be pivoted to move the suction-adhering portion thereof instead of pivoting the male-side suction cup. In this case, the displaced position of the suction-adhering portion of the female-side suction cup is located more away from the bag mouth than the mutually facing position. It is also possible to pivot both the suction cups.

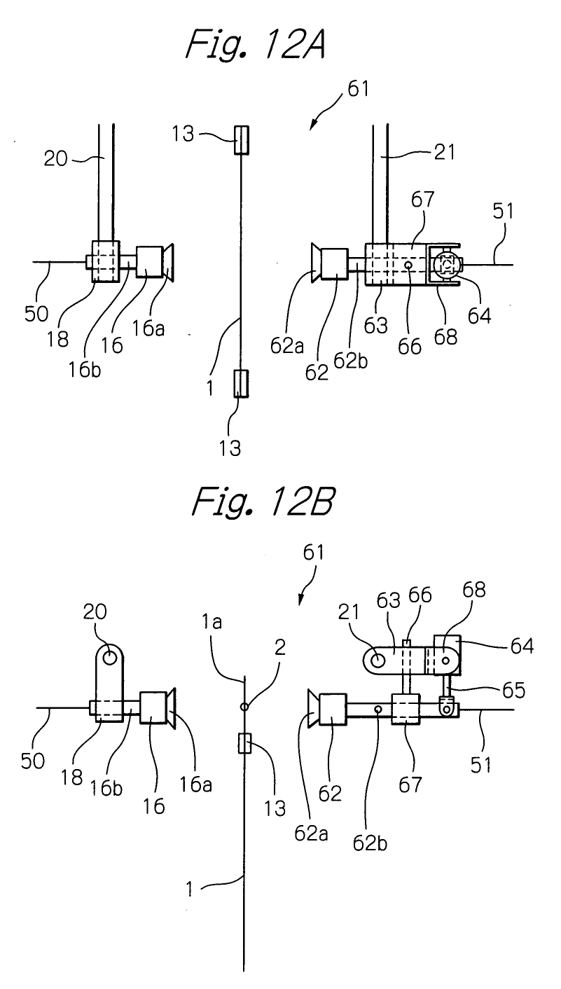

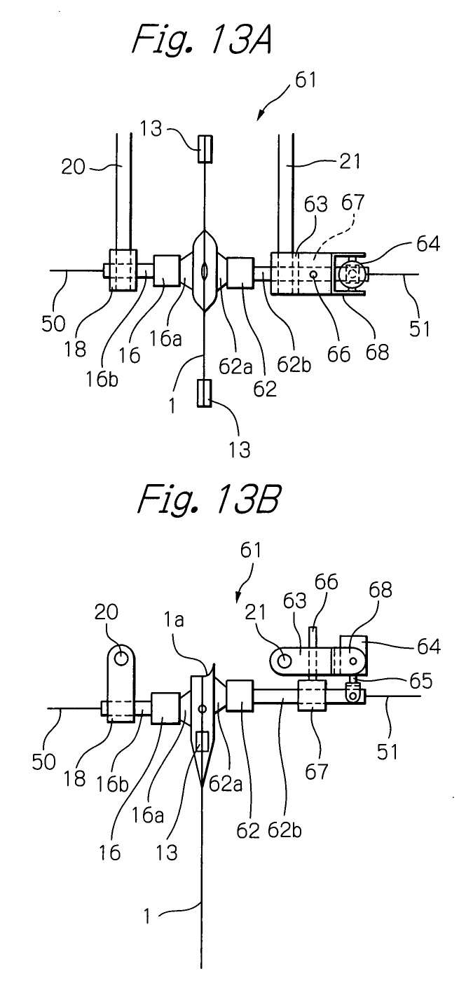

A zipper element disengaging apparatus 61 according to a second embodiment of the present invention will be explained below with reference to FIGS. 12A to 13B. In this embodiment, the female-side suction cup and the members associated therewith are the same as those in the first embodiment. Therefore, they are denoted by the same reference numerals as those used in the first embodiment, and a description thereof is omitted.

FIGS. 12A and 12B show one operation step of the zipper element disengaging apparatus 61 corresponding to the operation step in the first embodiment shown in FIGS. 3A and 3B. A male-side suction cup 62 in this embodiment differs from the male-side suction cup 17 in the first embodiment in the way in which it is attached to a holder 63. That is, the holder 63 is secured at the left end thereof to the distal end of the arm 21, which may be the same as that in the first embodiment. An air cylinder 64 is attached to the right end of the holder 63 through a bracket 68 so that a rod 65 of the air cylinder 64 extends downward in the same way as in the first embodiment. The rod 65 is attached at the distal end thereof to the end of a shaft portion 62b of the suction cup 62. In addition, a downwardly extending guide shaft 66 is vertically movably guided through a hole provided in the holder 63 at a horizontally intermediate position thereon. A support block 67 is secured to the lower end of the guide shaft 66. The support block 67 is secured to the shaft portion 62b of the suction cup 62. Accordingly, in response to the extension or contraction of the rod 65 of the air cylinder 64, the suction cup 62 moves downward or upward in the horizontal position illustrated in FIG. 12B.

FIGS. 13A and 13B show another operation step of the zipper element disengaging apparatus 61 corresponding to the operation step in the first embodiment shown in FIGS. 5A and 5B. That is, the arms 20 and 21 move toward each other from the respective positions shown in FIGS. 12A and 12B so that the suction-adhering portions 16a and 62a of the suction cups 16 and 62 adhere to the bag 1 at the respective outsides of the female element 4 and the male element 3 of the zipper 2 (not shown in the figures). Thereafter, both the suction cups 16 and 62 move away from each other by a predetermined distance, and at the same time, the air cylinder 64 is actuated to contract the rod 65 by a predetermined length. Thus, the suction-adhering portion 62a of the male-side suction cup 62 is moved to a displaced position where it is displaced toward the mouth 1a of the bag 1 relative to the suction-adhering portion 16a of the female-side suction cup 16.

The operations of the zipper element disengaging apparatus 61 according to the second embodiment other than the above will be understood from the description of the first embodiment. Therefore, a description of the other operations is omitted. The female-side suction cup 16 may be moved downward in the figures instead of moving the suction cup 62, or alternatively, both the suction cups 16 and 62 may be moved, as in the case of the first embodiment.

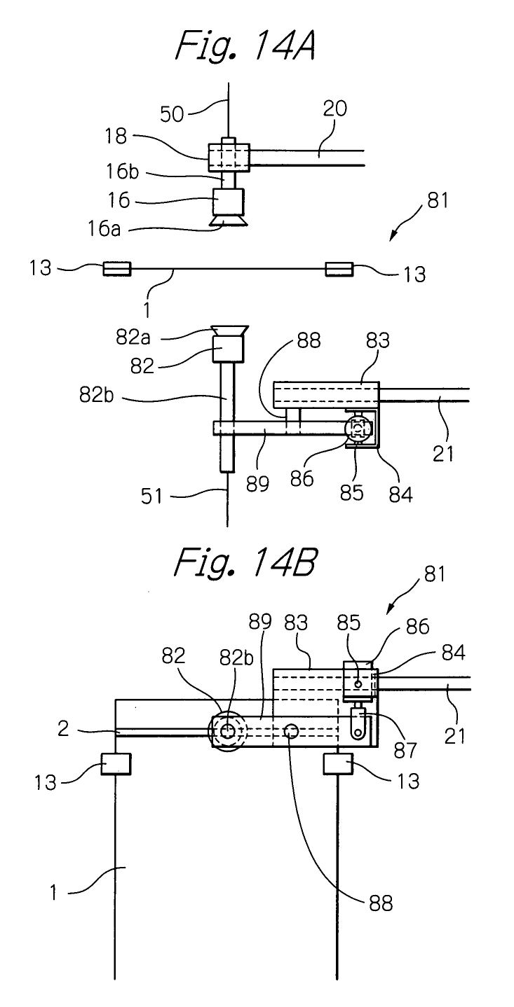

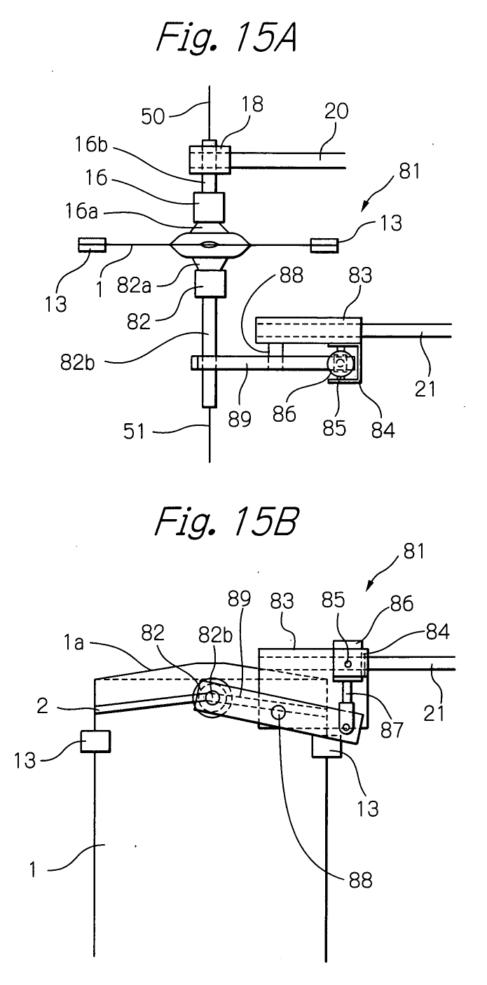

A zipper element disengaging apparatus 81 according to a third embodiment of the present invention will be explained below with reference to FIGS. 14A to 15B. In this embodiment also, the female-side suction cup and the members associated therewith are the same as those in the first embodiment. Therefore, they are denoted by the same reference numerals as those used in the first embodiment, and a description thereof is omitted. FIGS. 14A and 14B show one operation step of the zipper element disengaging apparatus 81 corresponding to the operation step in the first embodiment shown in FIGS. 3A and 3B. It should be noted, however, that FIG. 14B is a side view of the zipper element disengaging apparatus 81, shown in the plan view of FIG. 14A, as seen in a direction different from that in the case of FIG. 3B. That is, the direction in which the side view is taken is changed for the sake of convenience. In this embodiment also, a male-side suction cup 82 differs from the male-side suction cup 17 in the first embodiment in the way in which it is attached to a holder 83 and in the way in which it operates.

The holder 83 is secured to the distal end of the arm 21 for the male-side suction cup 82. A U-shaped bracket 84 is attached to a side of the holder 83 remote from the bag 1. An air cylinder 86 is supported downward by a support shaft 85 inside the bracket 84 so as to be pivotable about the support shaft 85. The air cylinder 86 has a rod 87 extending downward. Meanwhile, a swing lever 89 is swingably attached through a support shaft 88 to the holder 83 on the same side as the bracket 84. The distal end of the rod 87 of the air cylinder 86 is pivotably attached to one end of the swing lever 89. The shaft portion 82b of the male-side suction cup 82 is secured to the other end of the swing lever 89. Accordingly, when the rod 87 of the air cylinder 86 extends, the swing lever 89 pivots clockwise in FIG. 14B, causing the whole suction cup 82 to move clockwise with the shaft portion 82b thereof kept in the horizontal position. Thus, the suction-adhering portion 82a of the suction cup 82 is displaced toward the mouth 1a of the bag 1.

FIGS. 15A and 15B show another operation step of the zipper element disengaging apparatus 81 corresponding to the operation step in the first embodiment shown in FIGS. 5A and 5B. It should be noted, however, that the direction in which the zipper element disengaging apparatus 81 is seen in the side view of FIG. 15B is different from that in FIG. 5B, as in the case of FIG. 14B. The arms 20 and 21 move toward each other from the respective positions shown in FIGS. 14A and 14B so that the suction-adhering portions 16a and 82a of the suction cups 16 and 82 adhere to the bag 1 at the respective outsides of the female element 4 and the male element 3 of the zipper 2 (not shown in the figures). Thereafter, both the suction cups 16 and 82 move away from each other by a predetermined distance, and at the same time, the air cylinder 86 is actuated to extend the rod 87 by a predetermined length. Thus, the suction-adhering portion 82a of the male-side suction cup 82 is moved to a displaced position where it is displaced toward the mouth 1a of the bag 1 relative to the suction-adhering portion 16a of the female-side suction cup 16.

The operations of the zipper element disengaging apparatus 81 according to the third embodiment other than the above will be understood from the description of the first embodiment. Therefore, a description of the other operations is omitted. The female-side suction cup 16 may be moved to a displaced position instead of moving the suction cup 82, or alternatively, both the suction cups 16 and 82 may be moved, as in the case of the first embodiment.

Although in the foregoing description the present invention is applied to an automatic packaging machine in which a turntable is rotated intermittently to perform packaging, the zipper element disengaging apparatus according to the present invention is also applicable to a horizontal bag filling and packaging machine. The present invention can also be applied to a continuously moving type bag filling and packaging machine in which bags are moved not intermittently but continuously to perform filling and packaging. In this case, the zipper element disengaging apparatus according to the present invention may be moved to follow the continuous movement of a bag to unzip the zipper thereof and thereafter returned to the previous position to perform unzipping of the subsequent bag.

It should be noted that the present invention is not limited to the foregoing embodiments but can be modified in a variety of ways.

What is claimed is:

1. A zipper element disengaging apparatus for a packaging bag with a zipper having a pair of mating male and female zipper elements, said apparatus including a pair of grippers that grip laterally opposite side edges of said packaging bag, and a pair of suction-adhering members disposed in opposed relation to each other at both sides of said packaging bag, wherein said suction-adhering members are actuated to adhere to opposite side surfaces of said packaging bag in opposed relation to each other at respective outsides of said male zipper element and female zipper element, and said suction-adhering members adhering to said packaging bag are moved away from each other, thereby disengaging said male zipper element and female zipper element from each other, said apparatus comprising:
said pair of suction-adhering members having respective suction-adhering portions that adhere to said packaging bag;
an advancing and retracting device that holds said suction-adhering members and moves said suction-adhering members toward and away from each other; and
a suction-adhering member actuating device that moves at least one of said suction-adhering members between a mutually facing position where the suction-adhering portions of said suction-adhering members face each other and a displaced position where the suction-adhering portion of the suction-adhering member adhering to the outside of said male zipper element is displaced toward a mouth of said packaging bag relative to the suction-adhering portion of the suction-adhering member adhering to the outside of said female zipper element;
wherein when said suction-adhering members are moved away from each other by a predetermined distance by said advancing and retracting device, said suction-adhering member actuating device moves said at least one of said suction-adhering members from said mutually facing position to said displaced position.

2. A zipper element disengaging apparatus according to claim 1, wherein said suction-adhering member actuating device moves the suction-adhering member adhering to the outside of said male zipper element so that the suction-adhering portion of said suction-adhering member is displaced toward the mouth of said packaging bag.

3. A zipper element disengaging apparatus according to claim 2, wherein while said suction-adhering members remain at respective positions away from each other by said predetermined distance, said suction-adhering member actuating device returns the suction-adhering member adhering to the outside of said male zipper element moved to said displaced position to said mutually facing position and then reciprocates said suction-adhering member adhering to the outside of said male zipper element between said mutually facing position and displaced position at least one more time.

4. A zipper element disengaging apparatus according to claim 1, wherein said suction-adhering member actuating device moves the suction-adhering member adhering to the outside of said female zipper element so that the suction-adhering portion of said suction-adhering member is displaced away from the mouth of said packaging bag.

5. A zipper element disengaging apparatus according to claim 4, wherein while said suction-adhering members remain at respective positions away from each other by said predetermined distance, said suction-adhering member actuating device returns the suction-adhering member adhering to the outside of said female zipper element moved to said displaced position to said mutually facing position and then reciprocates said suction-adhering member adhering to the outside of said female zipper element between said mutually facing position and displaced position at least one more time.

6. A zipper element disengaging apparatus according to claim 1, wherein said suction-adhering member actuating device moves both said suction-adhering members so that the suction-adhering portion of the suction-adhering member adhering to the outside of said male zipper element is displaced toward the mouth of said packaging bag, and the suction-adhering portion of the suction-adhering member adhering to the outside of said female zipper element is displaced away from the mouth of said packaging bag.

7. A zipper element disengaging apparatus according to claim 6, wherein while said suction-adhering members remain at respective positions away from each other by said predetermined distance, said suction-adhering member actuating device returns both said suction-adhering members moved to said displaced position to said mutually facing position and then reciprocates both said suction-adhering members between said mutually facing position and displaced position at least one more time.

8. A zipper element disengaging apparatus according to claim 1, wherein while said suction-adhering members remain at respective positions away from each other by said predetermined distance, said suction-adhering member actuating device returns both said suction-adhering members moved to said displaced position to said mutually facing position and then reciprocates both said suction-adhering members between said mutually facing position and displaced position at least one more time.

9. A zipper element disengaging method for a packaging bag with a zipper having a pair of mating male and female zipper elements, comprising the steps of:
gripping laterally opposite side edges of said packaging bag with a pair of grippers;
disposing a pair of suction-adhering members having respective suction-adhering portions in opposed relation to each other at both sides of said packaging bag;
actuating said suction-adhering members so that the suction-adhering portions thereof adhere to said packaging bag in opposed relation to each other at respective outsides of said male zipper element and female zipper element; and
moving said suction-adhering members adhering to said packaging bag away from each other, thereby disengaging said male zipper element and female zipper element from each other;
wherein, in said step of moving said suction-adhering members away from each other, at least one of said suction-adhering members is moved from a mutually facing position where the suction-adhering portions of said suction-adhering members face each other to a displaced position where the suction-adhering portion of the suction-adhering member adhering to the outside of said male zipper element is displaced toward a mouth of said packaging bag relative to the suction-adhering portion of the suction-adhering member adhering to the outside of said female zipper element.

10. A zipper element disengaging method according to claim 9, wherein, in said step of moving said suction-adhering members away from each other, the suction-adhering member adhering to the outside of said male zipper element is moved from said mutually facing position to a displaced position where the suction-adhering portion of said suction-adhering member is displaced toward the mouth of said packaging bag.

11. A zipper element disengaging method according to claim 10, wherein while said suction-adhering members remain at respective positions away from each other by said predetermined distance, said suction-adhering member actuating device returns the suction-adhering member adhering to the outside of said male zipper element moved to said displaced position to said mutually facing position and then reciprocates said suction-adhering member adhering to the outside of said male zipper element between said mutually facing position and displaced position at least one more time.

12. A zipper element disengaging method according to claim 9, wherein, in said step of moving said suction-adhering members away from each other, the suction-adhering member adhering to the outside of said female zipper element is moved from said mutually facing position to a displaced position where the suction-adhering portion of said suction-adhering member is displaced away from the mouth of said packaging bag.

13. A zipper element disengaging method according to claim 12, wherein while said suction-adhering members remain at respective positions away from each other by said predetermined distance, said suction-adhering member actuating device returns the suction-adhering member adhering to the outside of said female zipper element moved to said displaced position to said mutually facing position and then reciprocates said suction-adhering member adhering to the outside of said female zipper element between said mutually facing position and displaced position at least one more time.

14. A zipper element disengaging method according to claim 9, wherein, in said step of moving said suction-adhering members away from each other, both said suction-adhering members are moved so that the suction-adhering portion of the suction-adhering member adhering to the outside of said male zipper element is displaced toward the mouth of said packaging bag, and at a same time, the suction-adhering portion of the suction-adhering member adhering to the outside of said female zipper element is displaced away from the mouth of said packaging bag.

15. A zipper element disengaging method according to claim 14, wherein while said suction-adhering members remain at respective positions away from each other by said predetermined distance, said suction-adhering member actuating device returns both said suction-adhering members moved to said displaced position to said mutually facing position and then reciprocates both said suction-adhering members between said mutually facing position and displaced position at least one more time.

16. A zipper element disengaging method according to claim 9, wherein while said suction-adhering members remain at respective positions away from each other by said predetermined distance, said suction-adhering member actuating device returns both said suction-adhering members moved to said displaced position to said mutually facing position and then reciprocates both said suction-adhering members between said mutually facing position and displaced position at least one more time.
